(19) United States
(12) Patent Application Publication
(10) Pub. No.: US 2026/0343476 A1
(43) Pub. Date: Oct. 29, 2026

(54) TAG CONTROLLER AND READER COORDINATION

(71) Applicant: QUALCOMM Incorporated, San Diego, CA (US)

(72) Inventors: Soo Bum LEE, San Diego, CA (US); Gavin Bernard HORN, La Jolla, CA (US)

(21) Appl. No.: 19/192,151

(22) Filed: Apr. 28, 2025

(51) Int. Cl. H04W 64/00; H04L 67/12; H04W 12/121

(52) U.S. Cl. CPC H04W 64/00; H04L 67/12; H04W 12/121

(57) ABSTRACT

Systems and techniques are provided for reader device coordination. For example, a process may include receiving, from a first reader device of a set of reader devices, capability information and state information for the first reader device; obtaining, from a second reader device, first information from an ambient internet of things (IoT) device; determining to obtain second information from the ambient IoT device; selecting the first reader device from the set of reader devices based on at least one of: a capability of the first reader device, a state of the first reader device, or a location of the first reader device; and transmitting, to the selected first reader device, a request to obtain the second information from the ambient IoT device.

### FIELD

Aspects of the present disclosure generally relate to wireless communications. For example, aspects of the present disclosure relate to coordination between a tag controller (e.g., an ambient Internet of Things (IoT) controller) and a reader device.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a device for reader device coordination is provided. The device includes a memory system comprising instructions and a processor system coupled to the memory system. The processor system is configured to: receive, from a first reader device of a set of reader devices, capability information and state information for the first reader device; obtain, from a second reader device, first information associated with an ambient internet of things (IoT) device; determine to obtain second information from the ambient IoT device; select the first reader device from the set of reader devices based on at least one of: a capability of the first reader device, a state of the first reader device, or a location of the first reader device; and transmit, to the selected first reader device, a request to obtain the second information from the ambient IoT device.

As another example, a method for reader device coordination is provided. The method includes: receiving, from a first reader device of a set of reader devices, capability information and state information for the first reader device; obtaining, from a second reader device, first information from an ambient internet of things (IoT) device; determining to obtain second information from the ambient IoT device; selecting the first reader device from the set of reader devices based on at least one of: a capability of the first reader device, a state of the first reader device, or a location of the first reader device; and transmitting, to the selected first reader device, a request to obtain the second information from the ambient IoT device.

In another example, a non-transitory computer-readable medium that has stored thereon instructions is provided. The instructions, when executed by one or more processors, cause the at one or more processors to: receive, from a first reader device of a set of reader devices, capability information and state information for the first reader device; obtain, from a second reader device, first information associated with an ambient internet of things (IoT) device; determine to obtain second information from the ambient IoT device; select the first reader device from the set of reader devices based on at least one of: a capability of the first reader device, a state of the first reader device, or a location of the first reader device; and transmit, to the selected first reader device, a request to obtain the second information from the ambient IoT device.

As another example, an apparatus for reader device coordination is provided. The apparatus includes means for receiving, from a first reader device of a set of reader devices, capability information and state information for the first reader device; means for obtaining, from a second reader device, first information from an ambient internet of things (IoT) device; means for determining to obtain second information from the ambient IoT device; means for selecting the first reader device from the set of reader devices based on at least one of: a capability of the first reader device, a state of the first reader device, or a location of the first reader device; and means for transmitting, to the selected first reader device, a request to obtain the second information from the ambient IoT device.

In another example, a reader device for wireless communication is provided. The reader device includes a memory system comprising instructions and a processor system coupled to the memory system. The processor system is configured to: transmit, to an ambient internet of things (IoT) controller, capability information and state information associated with the reader device; receive a request to obtain information from an ambient IoT device, wherein the request is received based on at least one of: a capability of the reader device, a state of the reader device, or a location of the reader device; communicate with the ambient IoT device based on the request to obtain information from the ambient IoT device; receive information from the ambient IoT device; and transmit the information from the ambient IoT device to the ambient IoT controller.

As another example, a method for wireless communication is provided. The method includes transmitting, to an ambient internet of things (IoT) controller, capability information and state information associated with a reader device; receiving a request to obtain information from an ambient IoT device, wherein the request is received based on at least one of: a capability of the reader device, a state of the reader device, or a location of the reader device; communicating with the ambient IoT device based on the request to obtain information to the ambient IoT device; receiving information from the ambient IoT device; and transmitting the information from the ambient IoT device to the ambient IoT controller.

In another example, a non-transitory computer-readable medium that has stored thereon instructions is provided. The instructions, when executed by one or more processors, cause the at one or more processors to: transmit, to an ambient internet of things (IoT) controller, capability information and state information associated with the device; receive a request to obtain information from an ambient IoT device, wherein the request is received based on at least one of: a capability of the device, a state of the device, or a location of the device; communicate with the ambient IoT device based on the request to obtain information from the ambient IoT device; receive information from the ambient IoT device; and transmit the information from the ambient IoT device to the ambient IoT controller.

As another example, an apparatus for wireless communication is provided. The apparatus includes means for transmitting, to an ambient internet of things (IoT) controller, capability information and state information associated with a reader device; means for receiving a request to obtain information from an ambient IoT device, wherein the request is received based on at least one of: a capability of the reader device, a state of the reader device, or a location of the reader device; means for communicating with the ambient IoT device based on the request to obtain information to the ambient IoT device; means for receiving information from the ambient IoT device; and means for transmitting the information from the ambient IoT device to the ambient IoT controller.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of a radio frequency (RF) energy harvesting device, in accordance with some examples;

FIG. 6 is an overview of an ambient IoT system, in accordance with aspects of the present disclosure;

FIG. 7A illustrates a wireless network ambient IoT deployment scenario, in accordance with aspects of the present disclosure;

FIG. 7B illustrates a third-party ambient IoT deployment scenario, in accordance with aspects of the present disclosure;

FIG. 7C illustrates a multi public land mobile network (PLMN) ambient IoT deployment scenario, in accordance with aspects of the present disclosure;

FIG. 8 is a block diagram illustrating an ambient IoT controller configured for reader device selection and coordination;

FIG. 9 is a flow diagram illustrating an example of a process for wireless communications, in accordance with some examples;

FIG. 10 is a flow diagram illustrating another example of a process for wireless communications, in accordance with some examples; and

FIG. 11 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc.

Based on harvesting energy from incident downlink RF signals (e.g., transmitted by a network device such as a base station, gNB, etc.), energy harvesting devices (e.g., such as passive IoT devices, semi-passive IoT devices, etc.) can be provided without an energy storage element and/or can be provided with a relatively small energy storage element (e.g., battery, capacitor, etc.). Energy harvesting devices can also be referred to as energy harvesting IoT devices. Energy harvesting devices can be deployed at large scales, based on the simplification in their manufacture and deployment associated with implementing wireless energy harvesting.

In a wireless communication network environment (e.g., cellular network, etc.), a network device (e.g., such as a base station or gNB, etc.) can be used to transmit downlink RF signals to energy harvesting IoT devices (e.g., passive and/or semi-passive IoT devices). Such a network device can be referred to as an energizing device or an energizer. In one illustrative example, a base station or gNB can read and/or write information stored on energy harvesting IoT devices by transmitting the downlink RF signal. A downlink RF signal can provide energy to an energy harvesting IoT device and can be used as the basis for an information-bearing uplink signal transmitted back to the network device by the energy harvesting IoT device (e.g., based on reflecting or backscattering a portion of the incident downlink RF signal). The base station or gNB can read the reflected signal transmitted by an energy harvesting IoT device to decode the information transmitted by the IoT device (e.g., such as sensor information collected by one or more sensors included in the IoT device, etc.).

Energy harvesting device (e.g., ambient IoT devices, tags, etc.) such as zero power IoT (ZP-IoT) devices, energy harvesting BluetoothTM low energy (EH-BLE) device, etc., may include passive IoT devices that rely on energy harvesting and passive communication (also referred to as low power communication) technologies, such as backscatter communications. With such technologies, low power and low cost of devices can be achieved. In some examples, for a given downlink signal with a given input RF power received at an ambient IoT device, the input RF power is provided to the device's energy harvester (e.g., with a percentage being converted to useful electrical power based on the conversion efficiency of the harvester and stored in an energy storage device, such as a battery, capacitor, etc. This stored power may be used for powering the device to perform tasks, such as processing, sensing, communications, displaying, etc. For example, the stored power may be used to listen (e.g., monitor) for downlink transmissions, receiving sensor information, updating displays, transmitting uplink messages, etc.

In some cases, the ambient IoT devices may be energized by an ambient IoT reader device (hereinafter “reader device”). A reader device may transmit a downlink signal to energize the ambient IoT devices and listen for a response from the ambient IoT devices. In some cases, the reader device may transmit commands to the ambient IoT devices and listen for responses to the commands. In some cases, the reader device may receive the responses from the ambient IoT devices and generate enrichment data. The reader device may send the responses and the enrichment data to a controller device. In some cases, the enrichment data may be data measured and provided by a reader device for a ambient IoT device. Examples of this enrichment data may include GNSS location information (e.g., provided via GNSS satellite-based systems, such as GPS, GLONASS, GNSS, BDS, and the like), neighboring cell IDs, sensor data, etc.

The controller device may instruct readers to forward certain commands to the ambient IoT devices. The controller may also receive responses to the commands from the reader device, along with enrichment data, if available. In some cases, the controller may process the enrichment data.

In some cases, an ambient IoT device may be within a range of multiple reader devices. For example, ambient IoT devices may be used for inventory tracking in a warehouse and many ambient IoT devices may be within range of a reader device. If a controller is connected to multiple reader devices and the controller blindly requests the connected reader devices to instruct ambient IoT devices within range of the reader device to respond, the controller may receive many redundant responses. For example, an ambient IoT device may receive the request and transmit a response. Multiple reader devices may be within range of the ambient IoT device and may receive the response transmitted from the ambient IoT device. Multiple reader reports for the ambient IoT device may then be received by the controller. These multiple reader reports for the ambient IoT device may be redundant, leading to potential congestion and/or wasted storage space. In some cases, reader selection and/or coordination may be useful.

Systems, apparatuses, processes (also referred to as methods), and computer-readable media (collectively referred to as “systems and techniques”) are described herein for techniques for reader coordination by an ambient IoT controller. For example, a reader device may register with a tag controller, for example, and send capability information and state information for the reader device to the ambient IoT controller. In some cases, the capability information may include information indicating what the reader device may include in the enrichment data. The enrichment data may include information detected by sensors of the reader device, such as GNSS sensors, cellular location information, wi-fi information, temperature sensors, motion sensors, etc. The state information may be information associated with (e.g., indicating, defining, etc.) the state of the reader device, such as the location of the reader device (e.g., independent of the ambient IoT devices), type of reader device, availability, battery level, mobility information, etc. The ambient IoT controller may track the state of the registered reader devices.

In some cases, the reader device may transmit a signal to energize the ambient IoT devices within range of the reader device. The reader device may then receive responses from the ambient IoT devices and forward the responses to the ambient IoT controller along with enrichment data. This enrichment data may include location information associated with the ambient IoT devices. The ambient IoT controller may track the location of the ambient IoT devices along with the last reader device (e.g., previous reader device) that received a response from a particular ambient IoT device. In some cases, the ambient IoT controller may manage geographical area lists for the ambient IoT devices along with a list of readers in each area. The ambient IoT controller may also track the mobility of the reader devices and ambient IoT devices.

In some cases, the ambient IoT controller may select a reader device to transmit a message for an ambient IoT device based on the capability information, the state information, the location of the reader device, any combination thereof, and/or based on other information. For example, a reader device may be selected based on the reader device previously receiving a message from a particular ambient IoT device, the reader device having coverage in an area the ambient IoT device is expected to be located, and/or the reader device not moving (having a “static” or “non-moving” state). As another example, an additional reader device may be selected based on a location of the additional reader device and based on the additional reader device having a capability to provide GNSS location information for the ambient IoT device. For example, the ambient IoT controller may determine a set of reader devices are in an area where a particular ambient IoT device is expected to be located and the ambient IoT controller may select, from the set of reader devices, those reader devices which may provide GNSS location information in the enrichment data accompanying responses from the ambient IoT devices.

The ambient IoT controller may send a request to the selected reader devices to obtain information from the ambient IoT devices within range of the reader device (e.g., close enough to the reader device to be energized by signals transmitted by the reader device sufficiently to transmit a response that can be received by the reader device).

In some cases, the ambient IoT controller may configure reader devices to automatically obtain information from ambient IoT devices (e.g., transmit signal to energize nearby ambient IoT devices) based on triggers. These triggers may be time based (e.g., periodically), or the triggers may be based on a certain event detected by sensors of the reader device such as based on changes in temperature, humidity, light, etc. In some cases, the ambient IoT controller may configure what enrichment data should be provided by a reader device with responses received by ambient IoT devices based on the capability information from the reader devices.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the Ues can be connected with external networks such as the Internet and with other Ues. Of course, other mechanisms of connecting to the core network and/or the Internet are also possible for the Ues, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with Ues depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by Ues, including supporting data, voice, and/or signaling connections for the supported Ues. In some systems, a base station may provide edge node signaling functions while in other systems it may provide additional control and/or network management functions. A communication link through which Ues can send signals to a base station is called an uplink (UL) channel (e.g., a reverse traffic channel, a reverse control channel, an access channel, etc.). A communication link through which the base station can send signals to Ues is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of Ues, a network entity or base station may not support wireless access by Ues (e.g., may not support data, voice, and/or signaling connections for Ues), but may instead transmit reference signals to Ues to be measured by the Ues, and/or may receive and measure signals transmitted by the Ues. Such a base station may be referred to as a positioning beacon (e.g., when transmitting signals to Ues) and/or as a location measurement unit (e.g., when receiving and measuring signals from Ues).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

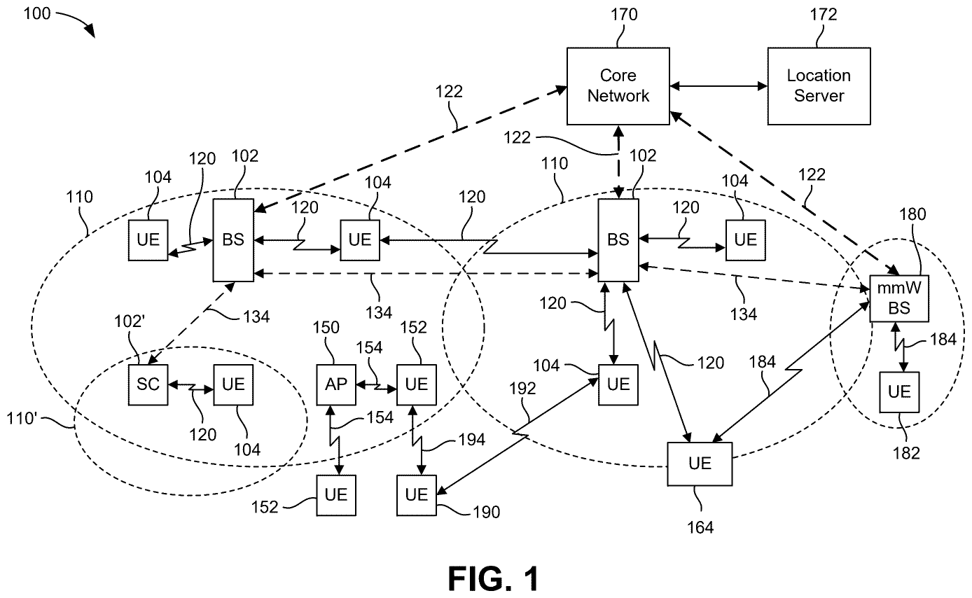

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of Ues. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., Ues, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “Pcell,” and the remaining carrier frequencies are referred to as “secondary carriers” or “secondary serving cells” or “Scells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a Pcell or an Scell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “Pcell”) and other frequencies utilized by the macro cell base stations 102 and/or the mmW base station 180 may be secondary carriers (“Scells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the Pcell or the active carrier frequency, and “Receiver 1” would need to tune from band ‘X’ to band ‘Y’ (e.g., an Scell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a Pcell and one or more Scells for the UE 164 and the mmW base station 180 may support one or more Scells for the UE 164.

The wireless communications system 100 may further include one or more Ues, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

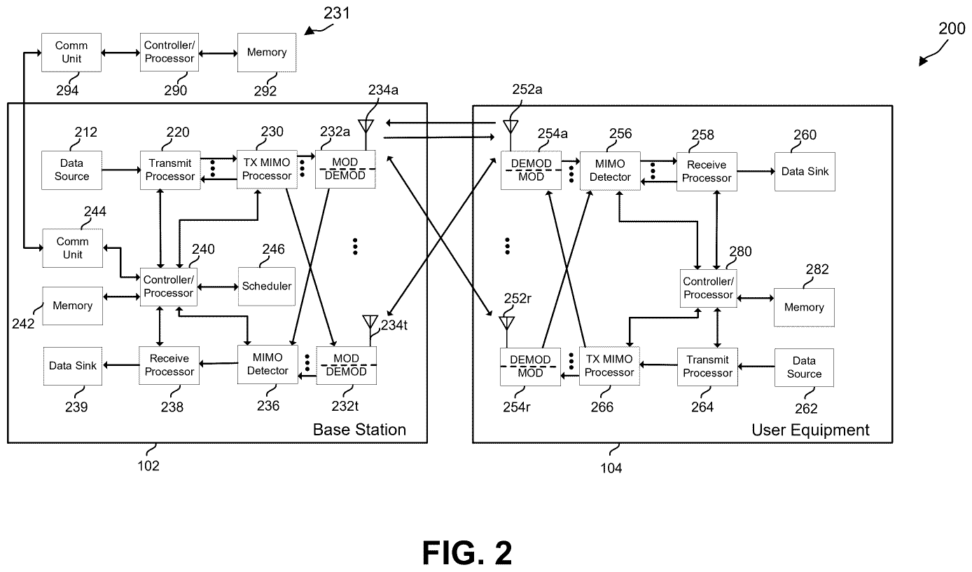

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more Ues, select one or more modulation and coding schemes (MCS) for each UE based on channel quality indicators (CQIs) received from the UE, process (e.g., encode and modulate) the data for each UE based on the MCS(s) selected for the UE, and provide data symbols for all Ues. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other Ues may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule Ues for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (Cus), one or more distributed units (Dus), or one or more radio units (Rus)). In some aspects, a CU may be implemented within a RAN node, and one or more Dus may be co-located with the CU, or alternatively, may be geographically or virtually distributed throughout one or multiple other RAN nodes. The Dus may be implemented to communicate with one or more Rus. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

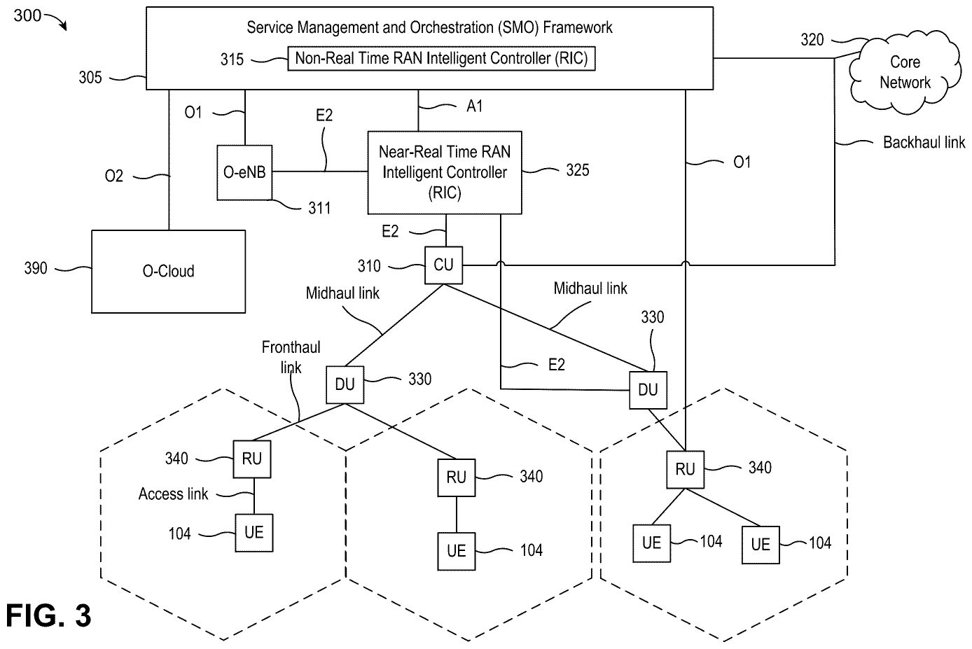

FIG. 3 is a diagram illustrating an example disaggregated base station 300 architecture. The disaggregated base station 300 architecture may include one or more central units (Cus) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more Rus 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

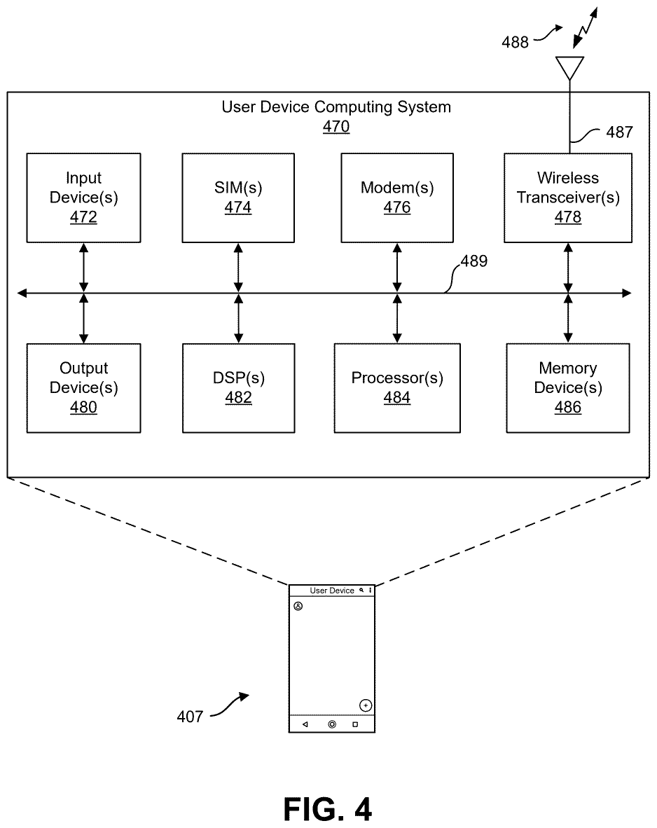

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, Aps, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (Aps) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

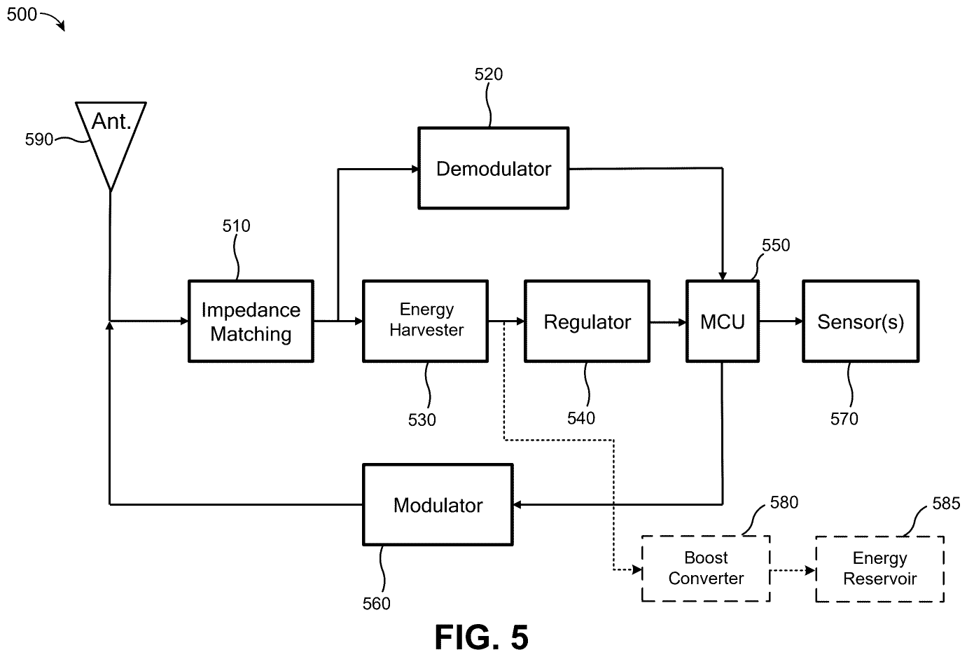

FIG. 5 is a diagram illustrating an example of an architecture of a radio frequency (RF) energy harvesting device 500, in accordance with some examples. A RF energy harvesting device 500 may be a type of ambient IoT device. As will be described in greater depth below, the RF energy harvesting device 500 can harvest RF energy from one or more RF signals received using an antenna 590. As used herein, the term “energy harvesting” may be used interchangeably with “power harvesting.” In some aspects, an “energy harvesting device” can be a device that is capable of performing energy harvesting (EH). For example, as used herein, the term “energy harvesting device” may be used interchangeably with the term “EH-capable device” or “energy harvesting-capable device.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna 590 to receive one or more downlink signals and to transmit one or more uplink signals. An impedance matching component 510 can be used to match the impedance of antenna 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a microcontroller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device, which perform passive uplink communication by modulating and reflecting a downlink signal received via antenna 590. A passive or semi-passive energy harvesting device may also be referred to as a passive or semi-passive EH-capable device, respectively. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An active or semi-passive energy harvesting device (e.g., also referred to as an active EH-capable device or a semi-passive EH-capable device, respectively) may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An active or semi-passive energy harvesting device may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device (e.g., also referred to as a “passive EH-capable device”) does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as a passive or semi-passive energy harvesting device, a continuous carrier wave downlink signal may be received using antenna 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna 590. Based on varying the antenna impedance (e.g., varying the impedance mismatch between antenna 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna 590 can be provided to a demodulator 520, which performs demodulation and provides a downlink communication (e.g., carried or modulated on the downlink signal) to a microcontroller unit (MCU) 550 or other processor included in the energy harvesting device 500. A remaining portion of the downlink signal received using antenna 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530 can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530 can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540 can remove or smooth spikes (e.g., increases) in the DC current output by energy harvester 530 (e.g., such that the DC current provided as input to MCU 550 by regulator 540 remains below a first threshold). In some cases, regulator 540 can remove or otherwise compensate for drops or decreases in the DC current output by energy harvester 530 (e.g., such that the DC current provided as input to MCU 550 by regulator 540 remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching component 510, demodulator 520, regulator 540, MCU 550, sensors 570, modulator 560, etc. For example, sensors 570 and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

In some cases, ambient IoT devices (e.g., tag devices) may be implemented as active devices, semi-passive energy harvesting devices, and passive energy harvesting devices. In some scenarios, ambient IoT devices may be used to locate and/or track lost or misplaced items. For example, an ambient IoT device may be attached to an item by an owner (e.g., user). If the owner loses or misplaces the item, the owner may then find and/or track a location of the attached ambient IoT device to help find the item. For some ambient IoT devices, if the item, and attached ambient IoT device, is misplaced by the owner, the ambient IoT may broadcast an announcement message using a relatively low energy protocol, such as Bluetooth Low Energy (BLE) protocol. Other ambient IoT devices may modulate a backscattered reflection to generate an announcement message. A nearby relay device (e.g., a reader device), such as a wireless device (which may not necessarily be associated with the owner of the ambient IoT device), may receive the announcement message and may transmit the announcement message along with location information associated with the relay device to a cloud service. The owner may then access the cloud service to access the location information as a proxy for where the ambient IoT device and attached item are located.

In some cases, ambient IoT devices may be relatively low-cost devices and may have relatively limited (or no) power source. Such ambient IoT devices may thus have a limited (or no) ability to perform complex processing, such as to implement a full cellular communications protocol stack, support more than minimal cryptographic processing, maintain a session or state over time, actively transmit messages, access SIM credentials, etc.

In some cases, communications with ambient IoT devices may be performed in certain scenarios. For example, a communications scenario may be an inventory scenario. An inventory scenario may be performed to determine the ambient IoT devices in a particular location and/or all of the ambient IoT devices that are reachable (e.g., can receive a message from a reader and transmit a response back to the reader) by a particular reader device. In an inventory scenario, a reader may transmit an inventory request message and ambient IoT devices within range may respond with, for example, an identifier and possibly additional information, depending on a configuration of the ambient IoT device.

Another example communications scenario may be a tracking scenario where a location of a specific ambient IoT device is determined. In the tracking scenario, the reader device may transmit a request message and an ambient IoT device may respond with a response message including an identifier for the ambient IoT device. The reader device may add enrichment data (e.g., location information for the reader device) to the response from the ambient IoT device and transmit the response and enrichment data to an ambient IoT network device, such as an ambient IoT controller. In some cases, enrichment data may be data gathered from a reader device and passed along with a response from an ambient IoT device, for example, to an ambient IoT controller. In some cases, the identifier (and/or any other information obtained from the ambient IoT device via the reader device) may be referred to as information (e.g., first information, second information, etc.) obtained or received from the ambient IoT device. In some cases, enrichment data may be referred to as information received from the reader device.

Another example communications scenario may be a trigger and/or command scenario. In the trigger and/or command scenario, certain commands and/or information may be sent by the reader device to one or multiple ambient IoT device and the ambient IoT device may respond with messages based on the trigger and/or command, such as with data read from the device, sensor information, an acknowledgment that a certain configuration has been applied (e.g., to the ambient IoT device itself, sensor connected to the ambient IoT device, etc.).

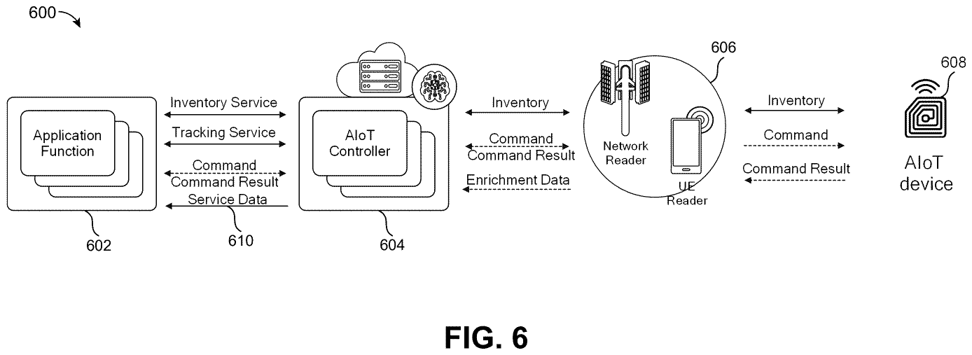

FIG. 6 is an overview of an ambient IoT system 600, in accordance with aspects of the present disclosure. In some cases, the ambient IoT system 600 may include one or more application functions 602, one or more ambient IoT controllers 604, one or more reader devices 606, and one or more ambient IoT devices 608. The one or more application functions 602 may be a part of, or coupled with, for example, a core network (e.g., core network 170 of FIG. 1, core network 320 of FIG. 3, etc.) of a wireless communications system (e.g., a wireless network operated by a wireless network operator). The application functions may interface with the wireless communications system and provide (e.g., host) ambient IoT related services for the wireless communications system. For example, the application functions 602 may receive user requests, such as to locate a lost ambient IoT device, and the application function 602 may generate commands to perform the user requests, such as requesting an inventory, requesting tracking of a device, and/or sending commands/triggers to an ambient IoT device. In some cases, the reader device may configure an ambient IoT device with a trigger. In some cases, the trigger may be periodic or based on a certain event detected by sensors of the reader device such as based on changes in temperature, humidity, light, etc. In some cases, the application function 602 may collect enrichment data and/or data from the one or more ambient IoT devices 608, for example, for analysis and/or output to a user.

The ambient IoT controllers 604 may be coupled to the application function 602. In some cases, the ambient IoT controllers 604 may also be a part of, or coupled with (e.g., via the internet/cloud), for example, a core network. The ambient IoT controllers 604 may coordinate the reader device 606 to perform commands for the application function 602. For example, the ambient IoT controllers 604 may instruct certain reader devices 606 to perform on demand, periodic, and/or scheduled inventories to identify one or more ambient IoT devices 608 in range of the reader devices 606. The ambient IoT controllers 604 may track a last known (e.g., previous) reader device 606 for each ambient IoT device 608, for example, to perform reachability management. If the ambient IoT controllers 604 receives a command to send an instruction (e.g., trigger and/or command) to a specific ambient IoT device, the ambient IoT controllers 604 may determine the last known (e.g., previous) reader device 606 for the ambient IoT device and forward the instruction to the determined last known reader device 606 for delivery to the specific ambient IoT device. If a command result (e.g., acknowledgment, returned data, etc.) is received from the specific ambient IoT device, the ambient IoT controllers 604 may forward the command result to the application function 602.

The ambient IoT controller 604 may also receive, collect, analyze, and/or make available enrichment data and/or data from the ambient IoT devices. In some cases, the ambient IoT controller 604 may process enrichment data from multiple reader devices 606 to generate service data 610. The service data 610 may be data generated from information received from multiple devices. For example, if the ambient IoT controller 604 is attempting to locate a specific ambient IoT device that is within range of multiple reader devices 606, the ambient IoT controller 604 may instruct the multiple reader devices 606 to track the ambient IoT device and receive enrichment data including location data from the multiple reader devices 606. As the location data may be based on the location of a particular reader device, the location data from a single reader device may not exactly reflect the location of the ambient IoT device. However, based on location data from multiple reader devices 606, the ambient IoT controller 604 may correlate the location data to determine an exact location of the ambient IoT device.

The reader devices 606 may be any device capable of transmitting a signal for energizing an ambient IoT device and/or receiving a response from the ambient IoT device. In some cases, the reader devices 606 may be transmit only devices, receive only devices, or transmit and receive devices. The reader devices 606 may include portable devices, such as a smartphone, mobile phone, scanner device, or any other portable device. The reader devices 606 may also include non-portable devices, such as network nodes (e.g., base stations 102 of FIG. 1, WLAN AP 150 of FIG. 1, mmW base station 180 of FIG. 1, CU 310, DU 330, RU 340 of FIG. 3, microcells, picocells, etc.), beacons, etc. In some cases, the reader devices 606 may receive commands/instructions from the ambient IoT controller, such as an indication to perform an inventory, forward a trigger/command, track an ambient IoT device, etc. In some cases, the reader device 606 may be configured by the ambient IoT controller 604, for example, to periodically (e.g., based on a certain period of time) perform an inventory, provide location information, etc.

The reader device 606 may perform the command, for example, by transmitting a signal to nearby ambient IoT devices based on the command and receiving a response and/or results of a command/trigger. In some cases, the reader device 606 may also generate enrichment data. Ambient IoT devices 608 may be relatively low-powered devices that may not, for example, have a sufficient power/processing budget to obtain location information or other sensor information. In some cases, an ambient IoT device may respond to an inventory/tracking request with an identifier of the ambient IoT device, and the reader device 606 may attach enrichment data to the response. For example, when tracking/locating an ambient IoT device, the reader device 606 may obtain its location information, attach the location information as enrichment data to a response from the ambient IoT device, and transmit the response and enrichment data to the ambient IoT controller 604. Other examples of enrichment data may include temperature, other meteorological information, altitude, and the like.

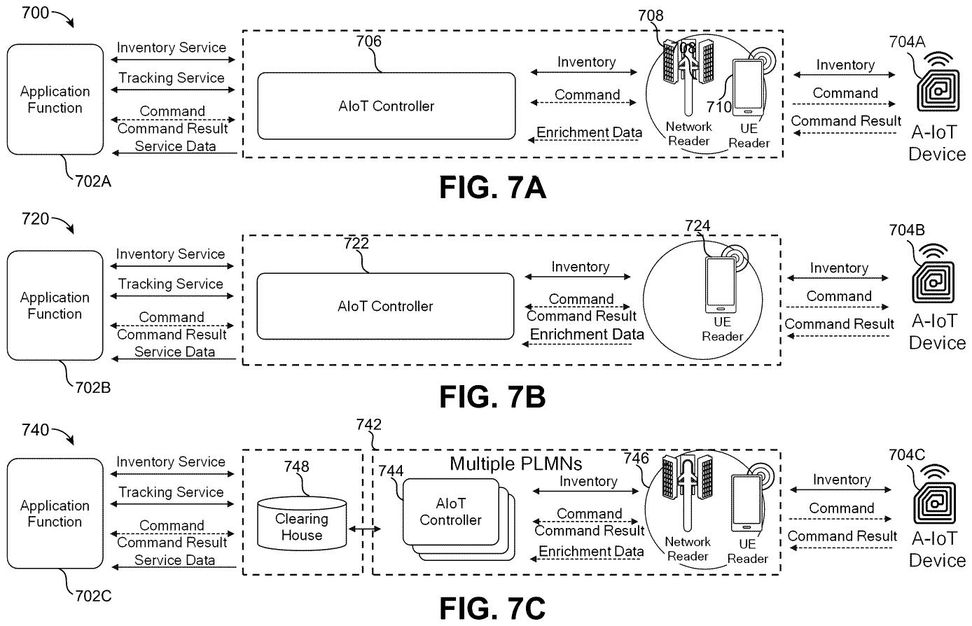

FIGS. 7A-7C illustrate potential deployment scenarios for ambient IoT devices. In each of the potential deployment scenario 700 of FIGS. 7A, 720 of FIG. 7B, and scenario 740 of FIG. 7C, an application function 702A, 702B, and 702C may be owned and/or managed by a third-party or a wireless network operator that may manage the ambient IoT devices 704A, 704B, and 704C. As discussed above, the application functions 702A-702C may be coupled to and/or hosted on a wireless network. Similarly, ambient IoT devices 704A-704C may be owned by third parties, such as individual users and the ambient IoT devices 704A-704C may have service via the third party responsible for the application functions 702A-702C. The application functions 702A-702C may be similar to application functions 602 of FIG. 6 and the ambient IoT devices may be similar to the ambient IoT devices 608 of FIG. 6.

FIG. 7A illustrates a wireless network ambient IoT deployment scenario 700, in accordance with aspects of the present disclosure. In the wireless network ambient IoT deployment scenario 700, a wireless network operator may operate and/or manage an ambient IoT controller 706. For example, the wireless network operator may configure one or more network nodes as network reader devices 708 to communicate (e.g., obtain information from) with the ambient IoT devices 704A. In some cases, the wireless network operator may also own, operate, and/or manage portable reader devices 710 (e.g., UE reader devices). The portable reader devices 710 may be portable devices connected to the wireless network capable of communicating with the ambient IoT devices 704A. In some cases, the portable reader devices 710 may be owned and/or operated by users and the portable reader devices 710 may be user-configured (e.g., via a user accessible setting) to communicate with ambient IoT devices 704A. The ambient IoT controller 706 may be similar to the ambient IoT controller 604 of FIG. 6 and the reader devices (e.g., network reader devices 708 and portable reader devices 710) may be similar to reader devices 606 of FIG. 6. The wireless network operator may also operate and/or manage a set of reader devices.

FIG. 7B illustrates a third-party ambient IoT deployment scenario 720, in accordance with aspects of the present disclosure. In the third-party ambient IoT deployment scenario 720, a third-party may own, manage, and/or operate an ambient IoT controller 722. In some cases, the third-party associated with the ambient IoT controller 722 may be the same third-party which owns/operates/manages the application function 702B. The ambient IoT controller 722 may be hosted on a wireless network and the ambient IoT controller 722 may communicate with a set of portable reader devices 724 via the wireless network.

The third-party may also own, manage, and/or operate the set of portable reader devices 724. For example, the portable reader devices 724 may include software associated with the third-party allowing the portable reader devices 724 to communicate with ambient IoT devices 704B as well as the ambient IoT controller 722 and/or application function 702B via the wireless network (or via other networks). In some cases, the third-party ambient IoT deployment scenario 720 may not include network reader devices as the third-party may be independent of a wireless network operator. The ambient IoT controller 722 may be similar to the ambient IoT controller 604 of FIG. 6 and the portable reader devices 724 may be similar to reader devices 606 of FIG. 6.

FIG. 7C illustrates a multi public land mobile network (PLMN) ambient IoT deployment scenario 740, in accordance with aspects of the present disclosure. The PLMN ambient IoT deployment scenario 740 may be similar to the wireless network ambient IoT deployment scenario 700 in that multiple wireless networks may have multiple wireless network ambient IoT deployments 742. In some cases, each wireless network ambient IoT deployments may have one or more ambient IoT controllers 744 communicating with sets of reader devices 746. In some cases, an application function 702C may communicate with the one or more ambient IoT controllers 744 of the multiple wireless networks via a clearing house 748 (e.g., data repository). The application function 702C may then be able to communicate with ambient IoT devices 704C using reader devices 746 from different wireless networks using the clearing house 748.

In some cases, there may be many reader devices in an area, such as a busy street, subway station, etc. Where there are many reader devices in an area attempting to communicate with ambient IoT devices (e.g., many reader devices transmitting inventory/tracking requests), the ambient IoT devices may respond unnecessarily, generating many redundant reports. These redundant reports may cause congestion, for example, where the ambient IoT devices may receive multiple overlapping requests and then tries to respond. Additionally, the redundant reports may take up extra storage space, which can add up over time.

In some cases, reader device selection and coordination may be used to help avoid redundancy. To facilitate reader device selection and coordination, reader devices may register their capabilities and state with an ambient IoT controller. The ambient IoT controller may then select and configure reader devices to communicate with the ambient IoT devices based on the reader device state and/or capabilities along with service requirements for the communications with the ambient IoT device.

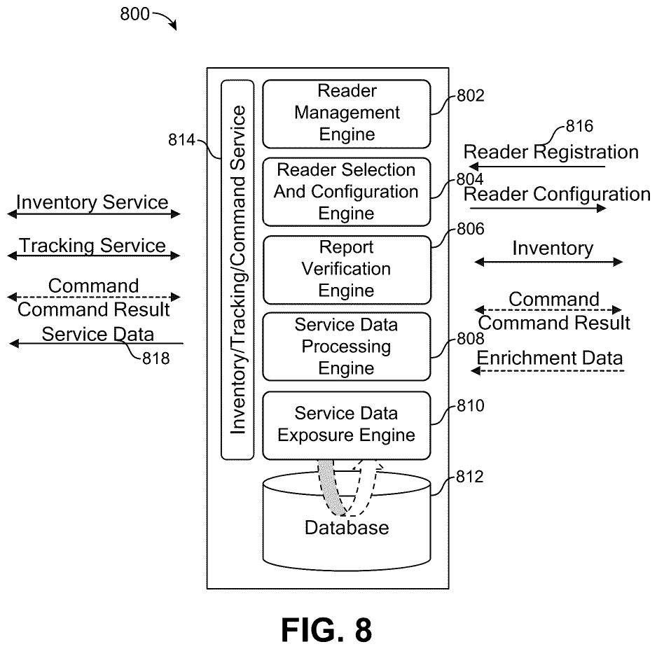

FIG. 8 is a block diagram illustrating an ambient IoT controller 800 configured for reader device selection and coordination. In FIG. 8, the ambient IoT controller 800 includes a reader management engine 802, a reader selection and configuration engine 804, a report verification engine 806, service data processing engine 808, service data exposure engine 810, a database 812 and an inventory, tracking, and/or command service 814.

As indicated above, a reader device may have a set of capabilities, such as what sensors are available on the reader device, whether the reader device can provide GNSS location information (e.g., provided via GNSS satellite based systems, such as GPS, GLONASS, GNSS, BDS, and the like), whether the reader device includes Wi-Fi capabilities, Bluetooth capabilities, and the like. The reader device may report its capabilities to the ambient IoT controller 800 as a part of reader device registration 816. In some cases, a reader device may report a subset of the capabilities of the reader device. For example, the reader device may be configured not to provide certain information, such as location information, certain sensor information, etc., and the reader device may not report those capabilities corresponding to the information the reader device is configured not to provide. In some cases, the reader management engine 802 of the ambient IoT controller 800 may receive the reader device registration 816 and capability information and store the received information in the database 812.

In some cases, the reader devices may also provide state information to the ambient IoT controller 800. The state information may include information associated with (e.g., indicating, defining, etc.) the reader device, such as type for the reader device (e.g., smartphone, dedicated reader device, device model information, etc.), whether the reader device is available (e.g., in idle mode, active state, connected state, etc.), battery information for the reader device, mobility information (e.g., stationary, highly mobile, etc.), location information (e.g., precise location, approximate location), nearby network nodes (e.g., base stations, access points, eNBs, gNBs, etc.), and the like. The reader management engine 802 of the ambient IoT controller may receive and maintain a state associated with a reader device using the received state information from the reader device. In some cases, the reader device may periodically (e.g., based on a certain period of time) report certain state information (e.g., state information that may change, such as mobility information, battery information, location information, etc.) to the ambient IoT controller 800. In some cases, the reader device may report state information to the ambient IoT controller 800 if the state information changes. The reader management engine 802 may update the state associated with the reader device based on the reported state information. In some cases, how the reader device reports state information may be configured, for example, by the reader management engine 802 of the ambient IoT controller 800. In some cases, a subset of the state information may be reported by the reader device. For example, the reader device may provide a location of the reader device without providing other state information, such as the battery information. In some cases, the state information may be provided directly from the reader device or obtained indirectly. For example, if the reader device is a base station, then the ambient IoT controller may obtain a location of the base station indirectly from the wireless network.

In some cases, the reader management engine 802 may also maintain (e.g., generate, manage, etc.) a list (e.g., database, table, array, and/or any other data structure) of the ambient IoT devices from which a message has been received. The reader management engine 802 may also track and/or identify the reader device which last received a message from each ambient IoT device. For example, if an ambient IoT device transmits a response to a reader device, the reader device may forward the response to the ambient IoT controller 800. The reader management engine 802 may then associate the reader device with the ambient IoT device (e.g., based on an identifier for the ambient IoT device contained in the message), identifying that reader device as the last reader device to have received a message from the ambient IoT device. Based on this association and the maintained state for the reader devices, the reader management engine 802 may determine an approximate location of the reader and the ambient IoT device. In some cases, the reader management engine 802 may maintain a set of geographical areas along with lists (e.g., database, table, array, and/or any other data structure) of the reader devices and ambient IoT devices which are likely within each geographical area of the set of geographical areas.

The reader selection and configuration engine 804 may select and/or configure reader devices to communicate with ambient IoT devices. In some cases, the reader selection and configuration engine 804 may use the maintained state for the reader devices, reader device capabilities, information associated with the last reader device to receive a transmission from an ambient IoT device, and lists of the reader device and ambient IoT devices for the geographical areas to determine which reader devices may be used to communicate with the ambient IoT devices. As an example, the reader selection and configuration engine 804 may select a reader device to communicate with ambient IoT devices associated with a particular location based on the last reader device to receive a transmission from the ambient IoT device, reader device availability and/or coverage, registered capabilities of the reader device, and the maintained state for the reader devices. In some cases, where a reader device is located may influence an expected coverage of the reader device. The coverage may refer to an amount of area that the back-scattering signal transmitted by the reader device may reach with a sufficient strength for an ambient IoT device to use to power transmission of a response. The expected coverage may be influenced, for example, based on whether the reader device is located in a room, an open area, etc.

As an example of how the maintained state and information associated with the last reader device to receive a transmission from the ambient IoT device may be used to select a reader device, if an ambient IoT device is of a type that is typically stationary (e.g., a temperature sensor, humidity sensor, etc.) the reader selection and configuration engine 804 may select a stationary reader device located near where the last reader device to have received a message from the ambient IoT device was located to communicate with the ambient IoT device. In some cases, if the last reader device to receive a transmission from the ambient IoT device is a stationary device, the reader selection and configuration engine 804 may reselect the last reader device that received the transmission from the ambient IoT device.

As an example of how the reader device capabilities may be used to select a reader device, if the ambient IoT controller 800 is attempting to obtain a certain type of enrichment data, such as location information, sensor information, etc., the reader selection and configuration engine 804 may select a reader device based in part on the reader device capabilities indicating that the reader device can provide the type of enrichment data being obtained.

In some cases, the reader selection and configuration engine 804 may select a reader device based on a type of message to be sent to the ambient IoT device. For example, the reader selection and configuration engine 804 may select a first reader device to transmit an inventory request message, but select a second reader device to transmit a tracking request message.

In some cases, the reader selection and configuration engine 804 may configure certain reader devices. For example, where a stationary ambient IoT device that provides sensor information is polled every regularly, such as every 30 seconds, rather than performing a reader device selection each time the ambient IoT device is to be polled, the reader selection and configuration engine 804 may configure a nearby, stationary, reader device to poll the ambient IoT device (e.g., transmit a request for the data) at a particular rate and to transmit the received sensor information to the ambient IoT controller 800. In some cases, the reader selection and configuration engine 804 may configure a reader device with a message to transmit (e.g., inventory message, tracking message, etc.), along with information for how the message should be sent. For example, the configuration information for an inventory message may include information associated with (e.g., indicating, defining, etc.) a periodicity, backoff policy (e.g., for congestion and/or contention), maximum/minimum number of retries, whether to transmit an indication of a failure (e.g., failure report) if there is no response from the ambient IoT device, what enrichment data (if any) should be provided by the reader device, conditions under which to start/stop transmitting the message to the ambient IoT device (e.g., start transmitting the inventory message based on an event (e.g., occurrence of an event), such as a temperature/humidity change above a certain threshold), and the like.

The report verification engine 806 may verify identifiers transmitted by the ambient IoT devices in response to messages from the reader devices. For example, the identifiers transmitted by the ambient IoT devices may not be a permanent identifier for security and/or privacy concerns, but rather a temporary identifier that may be periodically changed. In some cases, an application function (e.g., application functions 702A-702C of FIG. 7A, application function 602 of FIG. 6) may maintain information associated with (e.g., indicating, defining, etc.) a current temporary identifier for a given ambient IoT device. In some cases, the application function may provide the report verification engine 806 of the ambient IoT controller 800 an indication (e.g., list, database, table, array, and/or any other data structure) of identifiers for the ambient IoT device(s) that the application function is trying to communicate with. The report verification engine 806 may then filter the responses received from the ambient IoT devices via the reader devices based on the indicated identifiers.

In some cases, the report verification engine 806 may also validate enrichment data received from the reader devices. For example, the report verification engine 806 may perform outlier filtering to remove enrichment data that may be outside of a range that the report verification engine 806 may consider valid. As a more specific example, if the enrichment data includes temperature information, the report verification engine 806 may, for example, have a valid range of −40 degrees to 40 degrees C. If a received response includes enrichment data indicating that the temperature is −273 degrees C, then the report verification engine 806 may reject the enrichment data.

The service data processing engine 808 may process the enrichment data to generate service data 818 that may be sent, for example, to the application function. In some cases, the service data processing engine 808 may receive filtered enrichment data from the report verification engine 806 and combine and/or otherwise process multiple enrichment data obtained from multiple reader devices. In some cases, the service data processing engine 808 may determine to that enrichment data from multiple reader devices may be combined when the enrichment data are received from different reader devices at similar times and/or the multiple reader devices are near each other. The service data processing engine 808 may combine the enrichment data, for example, by determining an average (e.g., mode, mean, variance, etc.) of the received enrichment data. In some cases, the service data processing engine may perform any type of statistical analysis and/or data analytics of the enrichment data and/or data collected directly from the ambient IoT device (e.g., sensor data from an ambient IoT device having a sensor). As an example, where multiple reader devices are reporting location information (e.g., of the reader devices) in the enrichment data for a particular ambient IoT device at a similar time, the service data processing engine 808 may determine a more precise location of the ambient IoT device based on the location information from the multiple reader devices, for example, by triangulation from the multiple locations of the reader devices.

In some cases, the service data processing engine 808 may also be used to enhance reader device privacy. For example, as indicated above, enrichment data, such as location information, may be provided by a reader device, rather than the ambient IoT device itself. In some cases, the reader device may include an identifier for the reader device along with the response from the ambient IoT device and/or enrichment message. The service data processing engine 808 may filter out the reader device identifiers when generating the service data 818. The service data processing engine 808 may also just provide the combined service data 818 (e.g., the more precise location of the ambient IoT device) without providing the enrichment data (e.g., with the location information for the reader devices) to the application function.

In some cases, the report verification engine 806 may also perform outlier rejection. For example, as the service data processing engine 808 may receive data from multiple sources, the service data processing engine 808 may be able to more precisely detect outliers by comparing the data from the multiple sources. As an example, if five reader devices are reporting location information in the enrichment data for a particular ambient IoT device at a similar time where the location information for four of the reader devices are relatively close to each other and the location information from one of the reader devices indicates that the reader device is much further away, the location information from the one reader device may be rejected as an outlier.

In some cases, the report verification engine 806 may attempt to identity potentially malicious, spoofed, and/or suspect ambient IoT devices. For example, assuming that the reader devices are not maliciously reporting ambient IoT device identifiers, the report verification engine 806 may verify that an identifier associated with a particular ambient IoT device is not being reported by multiple reader devices which are an improbably large distance apart. For example, if an ambient IoT identifier is received from a first reader device at a first location and the same ambient IoT identifier is received from a second reader device that is a mile away from the first location one second later the report verification engine 806 may determine that the ambient IoT identifier may be malicious. Based on the determination that the ambient IoT identifier may be malicious, the ambient IoT controller 800 may quarantine ambient IoT identifier and may discard and/or flag data (and/or enrichment data) associated with the ambient IoT identifier. In some cases, the report verification engine 806 may also configure the reader devices to block or discard received responses from ambient IoT devices with the ambient IoT identifier. In some cases, the report verification engine 806 may also verify data received from the ambient IoT devices and/or enrichment data for potentially malicious data, for example, based on certain thresholds, such as temperature values above 255/256 (or below −128/above 127).

The service data exposure engine 810 may receive service data generated by the service data processing engine 808 and provide the service data to, for example, the application function. The inventory, tracking, and/or command service 814 may be a service that determines what messages to send to the ambient IoT devices based on requests (e.g., commands) received from, for example, the application function.

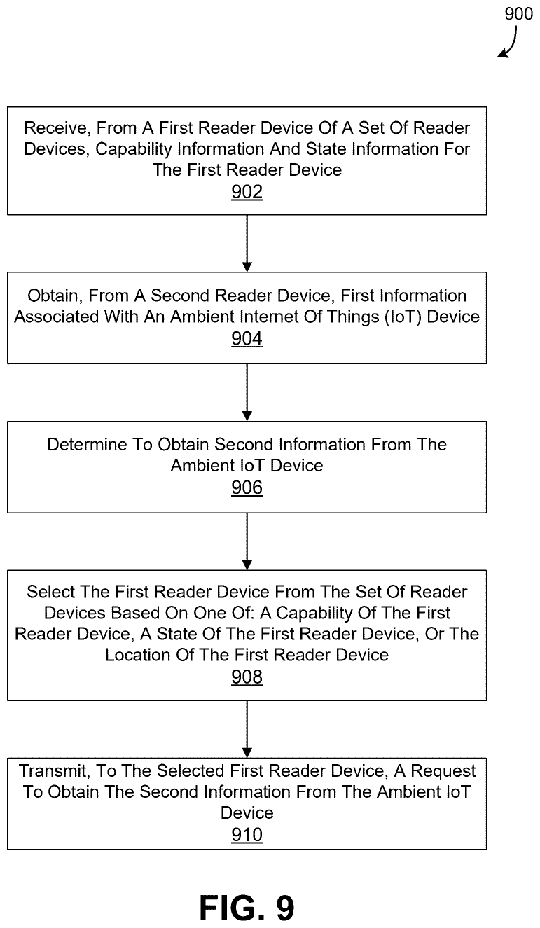

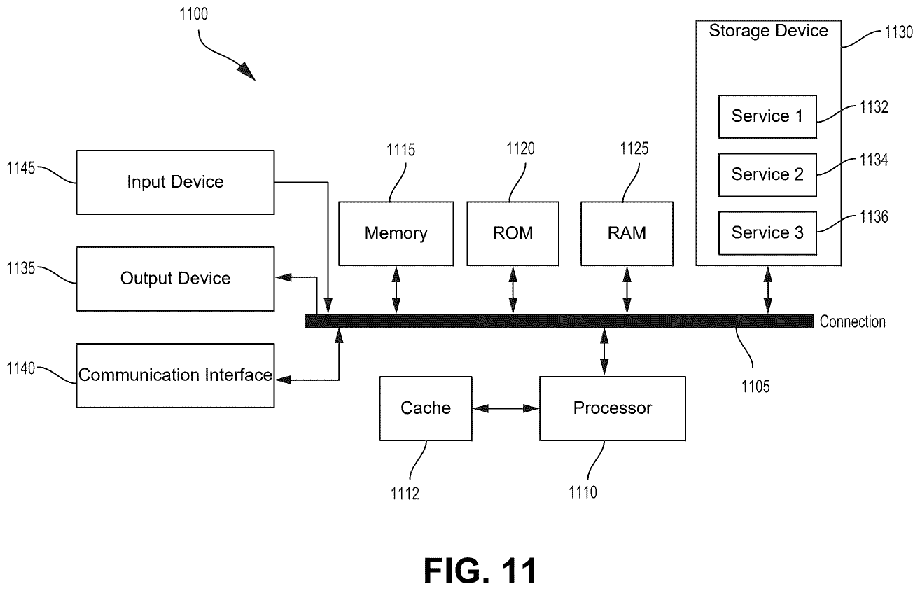

FIG. 9 is a flow diagram illustrating an example of a process 900 for wireless communications. The process 900 may be performed by a first wireless device (e.g., computing device) or by a component or system (e.g., a chipset) of the first wireless device. The computing device may be a ambient IoT controllers 604 of FIG. 6, ambient IoT controller 800 of FIG. 8, a wireless device, such as computing system 1100 of FIG. 11, or a UE (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network node. In some examples, the process 900 may be performed by a UE and/or an energy harvesting device. In some cases, the UE can be an energy harvesting device. The operations of the process 900 may be implemented as software components that are executed and run on one or more processors (e.g., processor 1110 of FIG. 11 or other processor(s)). Further, the transmission and reception of signals by the network device in the process 900 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communications interface 1140 of FIG. 11, or other antennae(s), transceiver(s), and/or component(s)).

At block 902 the computing device (or component thereof) may receive, from a first reader device (e.g., reader devices 606 of FIG. 6, network reader devices 708 of FIG. 7A, portable reader devices 724 of FIG. 7B, reader devices 746, of FIG. 7C, etc.) of a set of reader devices, capability information and state information for the first reader device. In some cases, the state information may include information associated with (e.g., indicating, defining, etc.) the reader device, such as type for the reader device (e.g., smartphone, dedicated reader device, device model information, etc.), whether the reader device is available (e.g., in idle mode, active state, connected state, etc.), battery information for the reader device, mobility information (e.g., stationary, highly mobile, etc.), location information (e.g., precise location, approximate location), nearby network nodes (e.g., base stations, access points, eNBs, gNBs, etc.), and the like. In some examples, a subset of the state information may be reported by the reader device. In some cases, the computing device (or component thereof) may receive updated state information from the first reader device. In some examples, the reader device may periodically (e.g., based on a certain period of time) report certain state information (e.g., state information that may change, such as mobility information, battery information, location information, etc.) to the ambient IoT controller. In some cases, the updated state information is received at least one of: periodically, or when the state information for the first reader device changes. In some examples, the reader device may report its capabilities, such as what sensors are available on the reader device, whether the reader device can provide GNSS location information (e.g., provided via GNSS satellite based systems, such as GPS, GLONASS, GNSS, BDS, and the like), whether the reader device includes Wi-Fi capabilities, Bluetooth capabilities, and the like, to the ambient IoT controller as a part of reader device registration. In some cases, the capability information indicates the capability of the first reader device. In some examples, the state information includes the location for the first reader device.

At block 904 the computing device (or component thereof) may obtain, from a second reader device, first information associated with an ambient internet of things (IoT) device (e.g., RF energy harvesting device 500 of FIG. 5, ambient IoT device 608 of FIG. 6, ambient IoT devices 704A, 704B, and 704C of FIGS. 7A, 7B, and 7C, respectively, etc.). For example, a reader selection and configuration engine may select a reader device based on a type of message to be sent to or type of data to obtain from the ambient IoT device. In some cases, the first information comprises an identifier for the ambient IoT device.

At block 906 the computing device (or component thereof) may determine to obtain second information from the ambient IoT device.

At block 908 the computing device (or component thereof) may select the first reader device from the set of reader devices based on at least one of: a capability of the first reader device, a state of the first reader device, or a location of the first reader device. In some cases, the computing device (or component thereof) may determine that the set of reader devices are located in an area and select the first reader device from the set of reader devices located in the area. In some examples, the computing device (or component thereof) may configure the first reader device to obtain the second information from the ambient IoT device based on a trigger. In some cases, the trigger comprises at least one of a period of time, or an event detected by a sensor of the first reader device. In some examples, the computing device (or component thereof) may configure the first reader device to report enrichment data for messages received from ambient IoT devices based on the capability information for the first reader device.

At block 910 the computing device (or component thereof) may transmit, to the selected first reader device, a request to obtain the second information from the ambient IoT device. In some cases, the computing device (or component thereof) may receive, via the selected first reader device, a response to the request to obtain the second information from the ambient IoT device. In some examples, the response to the request includes at least an identifier for the ambient IoT device. In some cases, the computing device (or component thereof) may receive, in response to the request, at least one of: enrichment data obtained by the selected first reader device; or ambient IoT data from the ambient IoT device. In some examples, the computing device (or component thereof) may combine the received enrichment data or ambient IoT data with additional enrichment data or additional ambient IoT data received from a third reader device (e.g., service data 610 of FIG. 6, service data 818 of FIG. 8). In some cases, the computing device (or component thereof) may determine to combine the received enrichment data or ambient IoT data with another enrichment data or another ambient IoT data based on at least one of: locations of the first reader device and the third reader device, or times when the enrichment data or ambient IoT data and another enrichment data or another ambient IoT data were obtained. In some examples, the computing device (or component thereof) may determine the enrichment data or ambient IoT data is an outlier or determine the identifier of the ambient IoT device is malicious.

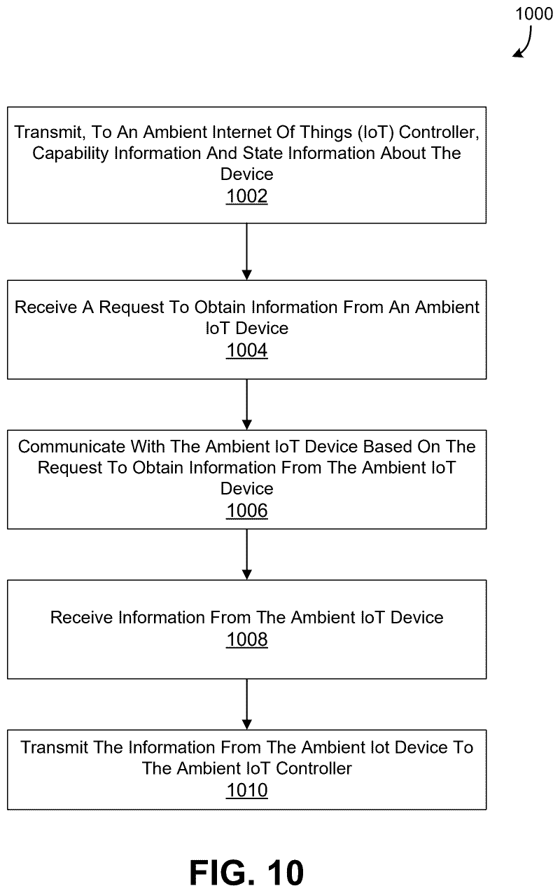

FIG. 10 is a flow diagram illustrating an example of a process 1000 for wireless communications. The process 1000 may be performed by a device (e.g., computing device) or by a component or system (e.g., a chipset) of the device (e.g., reader devices 606 of FIG. 6, network reader devices 708 of FIG. 7A, portable reader devices 724 of FIG. 7B, reader devices 746, of FIG. 7C, etc.). The device may be coupled to or a part of a core network (e.g., core network 170 of FIG. 1), and the device may be server device, such as computing system 1100 of FIG. 11 configured to provide and/or receive data from a UE (e.g., UE 104 of FIG. 1, wireless device 407 of FIG. 4, a mobile device such as a mobile phone, a network-connected wearable such as a watch, an extended reality device such as a virtual reality (VR) device or augmented reality (AR) device, a vehicle or component or system of a vehicle, or other type of UE) or other type of network node. The operations of the process 1000 may be implemented as software components that are executed and run on one or more processors (e.g., processor 1110 of FIG. 11 or other processor(s)).

At block 1002, the computing device (or component thereof) may transmit, to an ambient internet of things (IoT) controller (e.g., ambient IoT controllers 604 of FIG. 6, ambient IoT controller 800 of FIG. 8, etc.), capability information and state information associated with the device. In some cases, the state information may include information associated with (e.g., indicating, defining, etc.) the reader device, such as type for the reader device (e.g., smartphone, dedicated reader device, device model information, etc.), whether the reader device is available (e.g., in idle mode, active state, connected state, etc.), battery information for the reader device, mobility information (e.g., stationary, highly mobile, etc.), location information (e.g., precise location, approximate location), nearby network nodes (e.g., base stations, access points, eNBs, gNBs, etc.), and the like. In some examples, a subset of the state information may be reported by the reader device. In some cases, the reader device may report its capabilities, such as what sensors are available on the reader device, whether the reader device can provide GNSS location information (e.g., provided via GNSS satellite based systems, such as GPS, GLONASS, GNSS, BDS, and the like), whether the reader device includes Wi-Fi capabilities, Bluetooth capabilities, and the like, to the ambient IoT controller as a part of reader device registration. In some examples, the computing device (or component thereof) may transmit updated state information to the ambient IoT controller. In some cases, the computing device (or component thereof) may determine to transmit updated state information based on at least one of a determination that the state information has changed, or a period of time. In some examples, the computing device (or component thereof) may receive configuration information. In some cases, the configuration information configures the device to communicate with the ambient IoT device based on at least one of a period of time, or an occurrence of an event.

At block 1004, the computing device (or component thereof) may receive a request to obtain information from an ambient IoT device. In some cases, the request is received based on at least one of: a capability of the device, a state of the device, or a location of the device. In some examples, the request to obtain information comprises at least one of an inventory request, tracking request, or command request.

At block 1006, the computing device (or component thereof) may communicate with the ambient IoT device based on the request to obtain information from the ambient IoT device.

At block 1008, the computing device (or component thereof) may receive information from the ambient IoT device. In some cases, the computing device (or component thereof)) may determine, based on the request to obtain information, to obtain enrichment data and transmit the obtained enrichment data, along with the information from the ambient IoT device, to the ambient IoT controller.

At block 1010, the computing device (or component thereof) may transmit the information from the ambient IoT device to the ambient IoT controller.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the processes 900, 1000, and/or other processes described herein may include a processor, microprocessor, micro-computer, or other component of a device that is configured to carry out the steps of the processes 900, 1000, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the processes 900, 1000, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 900 and 1000 are illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the processes 900, 1000, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some aspects, computing system 1100 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1112 of high-speed memory connected directly with, in close proximity to, or integrated as part of processor 1110.

Processor 1110 may include any general-purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communications interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some aspects, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A device for reader device coordination comprising: a memory system comprising instructions; and a processor system coupled to the memory system, the processor system configured to: receive, from a first reader device of a set of reader devices, capability information and state information for the first reader device; obtain, from a second reader device, first information associated with an ambient internet of things (IoT) device; determine to obtain second information from the ambient IoT device; select the first reader device from the set of reader devices based on at least one of: a capability of the first reader device, a state of the first reader device, or a location of the first reader device; and transmit, to the selected first reader device, a request to obtain the second information from the ambient IoT device.

Aspect 2. The device of Aspect 1, wherein the processor system configured to: determine that the set of reader devices are located in an area; and select the first reader device from the set of reader devices located in the area.

Aspect 3. The device of any of Aspects 1-2, wherein the processor system configured to receive updated state information from the first reader device.

Aspect 4. The device of Aspect 3, wherein the updated state information is received at least one of: periodically, or when the state information for the first reader device changes.

Aspect 5. The device of any of Aspects 1-4, wherein the processor system configured to receive, via the selected first reader device, a response to the request to obtain the second information from the ambient IoT device, wherein the response to the request includes at least an identifier for the ambient IoT device.

Aspect 6. The device of Aspect 5, wherein the processor system is configured to receive, in response to the request, at least one of: enrichment data obtained by the selected first reader device; or ambient IoT data from the ambient IoT device.

Aspect 7. The device of Aspect 6, wherein the processor system is configured to combine the received enrichment data or ambient IoT data with additional enrichment data or additional ambient IoT data received from a third reader device.

Aspect 8. The device of Aspect 7, wherein the processor system is configured to determine to combine the received enrichment data or ambient IoT data with another enrichment data or another ambient IoT data based on at least one of: locations of the first reader device and the third reader device, or times when the enrichment data or ambient IoT data and another enrichment data or another ambient IoT data were obtained.

Aspect 9. The device of any of Aspects 6-8, wherein the processor system is configured to: determine the enrichment data or ambient IoT data is an outlier; or determine the identifier of the ambient IoT device is malicious.

Aspect 10. The device of any of Aspects 1-9, wherein the processor system is configured to configure the first reader device to obtain the second information from the ambient IoT device based on a trigger.

Aspect 11. The device of Aspect 10, wherein the trigger comprises at least one of a period of time, or an event detected by a sensor of the first reader device.

Aspect 12. The device of any of Aspects 1-11, wherein the processor system is configured to configure the first reader device to report enrichment data for messages received from ambient IoT devices based on the capability information for the first reader device.

Aspect 13. The device of any of Aspects 1-12, wherein the capability information indicates the capability of the first reader device, and wherein the state information includes the location for the first reader device.

Aspect 14. The device of any of Aspects 1-13, wherein the first information comprises an identifier for the ambient IoT device.

Aspect 15. A reader device for wireless communication, comprising: a memory system comprising instructions; and a processor system coupled to the memory system, the processor system configured to: transmit, to an ambient internet of things (IoT) controller, capability information and state information associated with the device; receive a request to obtain information from an ambient IoT device, wherein the request is received based on at least one of: a capability of the device, a state of the device, or a location of the device; communicate with the ambient IoT device based on the request to obtain information from the ambient IoT device; receive information from the ambient IoT device; and transmit the information from the ambient IoT device to the ambient IoT controller.

Aspect 16. The reader device of Aspect 15, wherein the processor system is configured to transmit updated state information to the ambient IoT controller.

Aspect 17. The reader device of Aspect 16, wherein the processor system is configured to determine to transmit updated state information based on at least one of a determination that the state information has changed, or a period of time.

Aspect 18. The reader device of any of Aspects 15-17, wherein the processor system is configured to: determine, based on the request to obtain information, to obtain enrichment data; and transmit the obtained enrichment data, along with the information from the ambient IoT device, to the ambient IoT controller.

Aspect 19. The reader device of any of Aspects 15-18, wherein the processor system is configured to receive configuration information, wherein the configuration information configures the device to communicate with the ambient IoT device based on at least one of a period of time, or an occurrence of an event.

Aspect 20. The reader device of any of Aspects 15-19, wherein the request to obtain information comprises at least one of an inventory request, tracking request, or command request.

Aspect 21. A method for reader device coordination, comprising: receiving, from a first reader device of a set of reader devices, capability information and state information for the first reader device; obtaining, from a second reader device, first information from an ambient internet of things (IoT) device; determining to obtain second information from the ambient IoT device; selecting the first reader device from the set of reader devices based on at least one of: a capability of the first reader device, a state of the first reader device, or a location of the first reader device; and transmitting, to the selected first reader device, a request to obtain the second information from the ambient IoT device.

Aspect 22. The method of Aspect 21, further comprising: determining that the set of reader devices are located in an area; and selecting the first reader device from the set of reader devices located in the area.

Aspect 23. The method of any of Aspects 21-22, further comprising receiving updated state information from the first reader device.

Aspect 24. The method of Aspect 23, wherein the updated state information is received at least one of: periodically, or when the state information for the reader device changes.

Aspect 25. The method of any of Aspects 21-24, further comprising receiving, via the selected first reader device, a response to the request to obtain the second information from the ambient IoT device, wherein the response to the request includes at least an identifier for the ambient IoT device.

Aspect 26. The method of Aspect 25, further comprising receiving, in response to the request, at least one of: enrichment data obtained by the selected first reader device; or ambient IoT data from the ambient IoT device.

Aspect 27. The method of Aspect 26, further comprising combining the received enrichment data or ambient IoT data with additional enrichment data or additional ambient IoT data received from a third reader device.

Aspect 28. The method of Aspect 27, further comprising determining to combine the received enrichment data or ambient IoT data with another enrichment data or another ambient IoT data based on at least one of: locations of the additional reader device and the additional reader device, or times when the enrichment data or ambient IoT data and another enrichment data or another ambient IoT data were obtained.

Aspect 29. The method of any of Aspects 26-28, further comprising: determining the enrichment data or ambient IoT data is an outlier; or determining the identifier of the ambient IoT device is malicious.

Aspect 30. The method of any of Aspects 21-29, further comprising configuring the first reader device to obtain the second information from the ambient IoT device based on a trigger.

Aspect 31. The method of Aspect 30, wherein the trigger comprises at least one of a period of time, or an event detected by a sensor of the first reader device.

Aspect 32. The method of any of Aspects 21-31, further comprising configuring the first reader device to report enrichment data for messages received from ambient IoT devices based on the capability information for the first reader device.

Aspect 33. The method of any of Aspects 21-32, wherein the capability information indicates the capability of the first reader device, and wherein the state information includes the location for the first reader device.

Aspect 34. The method of any of Aspects 21-33, wherein the first information comprises an identifier for the ambient IoT device.

Aspect 35. A method for wireless communication, comprising: transmitting, to an ambient internet of things (IoT) controller, capability information and state information associated with a reader device; receiving a request to obtain information from an ambient IoT device, wherein the request is received based on at least one of: a capability of the reader device, a state of the reader device, or a location of the reader device; communicating with the ambient IoT device based on the request to obtain information to the ambient IoT device; receiving information from the ambient IoT device; and transmitting the information from the ambient IoT device to the ambient IoT controller.

Aspect 36. The method of Aspect 35, further configured to transmit updated state information to the ambient IoT controller.

Aspect 37. The method of Aspect 36, further comprising determining to transmit updated state information based on at least one of a determination that the state information has changed, or a period of time.

Aspect 38. The method of any of Aspects 35-37 further comprising: determining, based on the request to obtain information, to obtain enrichment data; and transmitting the obtained enrichment data, along with the information from the ambient IoT device, to the ambient IoT controller.

Aspect 39. The method of any of Aspects 35-38, further comprising receiving configuration information, wherein the configuration information configures the reader device to communicate with the ambient IoT device based on at least one of a period of time, or an occurrence of an event.

Aspect 40. The method of any of Aspects 35-39, wherein the request to obtain information comprises at least one of an inventory request, tracking request, or command request.

Aspect 41. A non-transitory computer-readable medium having stored thereon instructions that, when executed by one or more processors, cause the one or more processors to perform operations according to any of Aspects 21-34.

Aspect 42. A non-transitory computer-readable medium having stored thereon instructions that, when executed by one or more processors, cause the one or more processors to perform operations according to any of Aspects 35-40.

Aspect 43. An apparatus for reader device coordination, comprising one or more means for performing operations according to any of Aspects 21-34.

Aspect 44. An apparatus for wireless communications, comprising one or more means for performing operations according to any of Aspects 35 to 40.

What is claimed is:

1. A device for reader device coordination comprising:
a memory system comprising instructions; and
a processor system coupled to the memory system, the processor system configured to:
receive, from a first reader device of a set of reader devices, capability information and state information for the first reader device;
obtain, from a second reader device, first information associated with an ambient internet of things (IoT) device;
determine to obtain second information from the ambient IoT device;
select the first reader device from the set of reader devices based on at least one of: a capability of the first reader device, a state of the first reader device, or a location of the first reader device; and
transmit, to the selected first reader device, a request to obtain the second information from the ambient IoT device.

2. The device of claim 1, wherein the processor system configured to:
determine that the set of reader devices are located in an area; and
select the first reader device from the set of reader devices located in the area.

3. The device of claim 1, wherein the processor system configured to receive updated state information from the first reader device.

4. The device of claim 3, wherein the updated state information is received at least one of: periodically, or when the state information for the first reader device changes.

5. The device of claim 1, wherein the processor system configured to receive, via the selected first reader device, a response to the request to obtain the second information from the ambient IoT device, wherein the response to the request includes at least an identifier for the ambient IoT device.

6. The device of claim 5, wherein the processor system is configured to receive, in response to the request, at least one of:
enrichment data obtained by the selected first reader device; or
ambient IoT data from the ambient IoT device.

7. The device of claim 6, wherein the processor system is configured to combine the received enrichment data or ambient IoT data with additional enrichment data or additional ambient IoT data received from a third reader device.

8. The device of claim 7, wherein the processor system is configured to determine to combine the received enrichment data or ambient IoT data with another enrichment data or another ambient IoT data based on at least one of:
locations of the first reader device and the third reader device, or
times when the enrichment data or ambient IoT data and another enrichment data or another ambient IoT data were obtained.

9. The device of claim 6, wherein the processor system is configured to:
determine the enrichment data or ambient IoT data is an outlier; or
determine the identifier of the ambient IoT device is malicious.

10. The device of claim 1, wherein the processor system is configured to configure the first reader device to obtain the second information from the ambient IoT device based on a trigger.

11. The device of claim 10, wherein the trigger comprises at least one of a period of time, or an event detected by a sensor of the first reader device.

12. The device of claim 1, wherein the processor system is configured to configure the first reader device to report enrichment data for messages received from ambient IoT devices based on the capability information for the first reader device.

13. The device of claim 1, wherein the capability information indicates the capability of the first reader device, and wherein the state information includes the location for the first reader device.

14. The device of claim 1, wherein the first information comprises an identifier for the ambient IoT device.

15. A reader device for wireless communication, comprising:
a memory system comprising instructions; and
a processor system coupled to the memory system, the processor system configured to:
transmit, to an ambient internet of things (IoT) controller, capability information and state information associated with the reader device;
receive a request to obtain information from an ambient IoT device, wherein the request is received based on at least one of: a capability of the reader device, a state of the reader device, or a location of the reader device;
communicate with the ambient IoT device based on the request to obtain information from the ambient IoT device;
receive information from the ambient IoT device; and
transmit the information from the ambient IoT device to the ambient IoT controller.

16. The reader device of claim 15, wherein the processor system is configured to transmit updated state information to the ambient IoT controller.

17. The reader device of claim 16, wherein the processor system is configured to determine to transmit updated state information based on at least one of a determination that the state information has changed, or a period of time.

18. The reader device of claim 15, wherein the processor system is configured to:
determine, based on the request to obtain information, to obtain enrichment data; and
transmit the obtained enrichment data, along with the information from the ambient IoT device, to the ambient IoT controller.

19. The reader device of claim 15, wherein the processor system is configured to receive configuration information, wherein the configuration information configures the reader device to communicate with the ambient IoT device based on at least one of a period of time, or an occurrence of an event.

20. The reader device of claim 15, wherein the request to obtain information comprises at least one of an inventory request, tracking request, or command request.

21. A method for reader device coordination, comprising:
receiving, from a first reader device of a set of reader devices, capability information and state information for the first reader device;
obtaining, from a second reader device, first information from an ambient internet of things (IoT) device;
determining to obtain second information from the ambient IoT device;
selecting the first reader device from the set of reader devices based on at least one of: a capability of the first reader device, a state of the first reader device, or a location of the first reader device; and
transmitting, to the selected first reader device, a request to obtain the second information from the ambient IoT device.

22. The method of claim 21, further comprising:
determining that the set of reader devices are located in an area; and
selecting the first reader device from the set of reader devices located in the area.

23. The method of claim 21, further comprising receiving updated state information from the first reader device.

24. The method of claim 23, wherein the updated state information is received at least one of: periodically, or when the state information for the reader device changes.

25. The method of claim 21, further comprising receiving, via the selected first reader device, a response to the request to obtain the second information from the ambient IoT device, wherein the response to the request includes at least an identifier for the ambient IoT device.

26. The method of claim 25, further comprising receiving, in response to the request, at least one of:
enrichment data obtained by the selected first reader device; or
ambient IoT data from the ambient IoT device.

27. The method of claim 26, further comprising combining the received enrichment data or ambient IoT data with additional enrichment data or additional ambient IoT data received from a third reader device.

28. The method of claim 27, further comprising determining to combine the received enrichment data or ambient IoT data with another enrichment data or another ambient IoT data based on at least one of:
locations of the additional reader device and the additional reader device, or
times when the enrichment data or ambient IoT data and another enrichment data or another ambient IoT data were obtained.

29. The method of claim 26, further comprising:
determining the enrichment data or ambient IoT data is an outlier; or
determining the identifier of the ambient IoT device is malicious.

30. The method of claim 21, further comprising configuring the first reader device to obtain the second information from the ambient IoT device based on a trigger.

31. The method of claim 30, wherein the trigger comprises at least one of a period of time, or an event detected by a sensor of the first reader device.

32. The method of claim 21, further comprising configuring the first reader device to report enrichment data for messages received from ambient IoT devices based on the capability information for the first reader device.

33. The method of claim 21, wherein the capability information indicates the capability of the first reader device, and wherein the state information includes the location for the first reader device.

34. The method of claim 21, wherein the first information comprises an identifier for the ambient IoT device.

35. A method for wireless communication, comprising:
transmitting, to an ambient internet of things (IoT) controller, capability information and state information associated with a reader device;
receiving a request to obtain information from an ambient IoT device, wherein the request is received based on at least one of: a capability of the reader device, a state of the reader device, or a location of the reader device;
communicating with the ambient IoT device based on the request to obtain information to the ambient IoT device;
receiving information from the ambient IoT device; and
transmitting the information from the ambient IoT device to the ambient IoT controller.

36. The method of claim 35, further configured to transmit updated state information to the ambient IoT controller.

37. The method of claim 36, further comprising determining to transmit updated state information based on at least one of a determination that the state information has changed, or a period of time.

38. The method of claim 35 further comprising:
determining, based on the request to obtain information, to obtain enrichment data; and
transmitting the obtained enrichment data, along with the information from the ambient IoT device, to the ambient IoT controller.

39. The method of claim 35, further comprising receiving configuration information, wherein the configuration information configures the reader device to communicate with the ambient IoT device based on at least one of a period of time, or an occurrence of an event.

40. The method of claim 35, wherein the request to obtain information comprises at least one of an inventory request, tracking request, or command request.
